(19) United States
(12) Patent Application Publication
(10) Pub. No.: US 2003/0110679 A1
(43) Pub. Date: Jun. 19, 2003

(54) Apparatus and method for the asthetic and unobtrusive trapping and disposing of rodents

(76) Inventor: Steve Collins, Boca Raton, FL (US)

Correspondence Address: David W. Barman, 1101 NE 176 Terrace, North Miami Beach, FL, 33162, US

(21) Appl. No.: 10/024,801

(22) Filed: Dec. 19, 2001

(51) Int. Cl. A01M 23/30; A01M 23/36

(52) U.S. Cl. 43/81

(57) ABSTRACT

The invention concerns an apparatus and method for capturing or eliminating rodents in an aesthetically, unobtrusive manner.

### FIELD OF THE INVENTION

The invention concerns a method and pest control article for capturing or eliminating rodents in an aesthetically, unobtrusive manner.

### BACKGROUND OF THE INVENTION

Everyone has heard of the quest to “build a better mousetrap.”

Rodents are uninvited intruders within our homes and businesses. Pest control is a major industry. Poisoned bait and traps are primary weapons in pest control. Unfortunately, these weapons must often be deployed in areas visible to others. Homeowners would prefer not to advertise that they have a pest control problem. Neighbors might conclude that the infested household is subject to poor housekeeping or other domestic sanitary failure.

Commercial establishments are even more seriously concerned with the problem. Customers must not be given the impression of unsanitary conditions. This is particularly so with hotels, restaurants, and all stores with edible merchandise. Traps left in the open on such premises are aesthetically displeasing; they leave a negative impression of the establishment in the minds of the public.

Rodent control has a long history. U.S. Pat. No. 619,754 (Hunter et al.) discloses a mousetrap based upon a guillotine principle. A choker-wire is housed within the body of a corncob. Presumably, at least some portion of the trapped mouse is held within the corncob body out of visible sight.

U.S. Pat. No. 2,637,931 (Sklar) discloses an animal trap based on a trigger-operated release mechanism allowing a spring-loaded jaw to close over the trapped animal body. A simulated cat's head will overlie at least a portion of a mouse so unfortunate as to encounter the spring-loaded jaw.

U.S. Pat. No. 3,992,803 (Kaiser) describes a miniature house opened at one end with a trap mechanism mounted on an inner wall. The arrangement is intended to allow disposal of the trapped dead animal without personal contact.

In all the foregoing described devices, the body of the caught rodent, at least in part, may not be visible publicly. Nonetheless, the traps themselves are in open view. They signal that the premises may have an infestation. A method is necessary to avoid the public embarrassment and negative press associated with traps in open view.

Accordingly, it is an object of the present invention to provide a method and article which can control rodents while still being out of view from anyone other than the homeowner or pest control engineers.

### SUMMARY OF THE INVENTION

In is an object of the invention to provide a rodent control article using a standard spring-loaded mouse or rattrap.

It is a further object of the invention to house the trap in an opaque housing.

It is another object of the invention to trap the rodent in a manner such that the expired rodent is hidden from view.

It is yet another object of the invention to provide a signaling means by which a user can determine the trap has been triggered.

It is still another object of the invention to dispose of the entire used trap and housing without the user touching or viewing the expired rodent.

### BREIF DESCRIPTION OF THE DRAWINGS

FIG. 1 Shows an exterior view of the subject invention.

FIG. 2 Shows a cut away and the interior components of the subject invention.

FIG. 3 Shows a cut away and the triggering of the indicator mechanism

FIG. 4 Shows a cut away side view and the triggering of the indicator mechanism.

### DETAILED DESCRIPTION OF THE PREFERRED EMBODIMENT

The standard spring-loaded trap, hereafter referred to as the trap, is still the cheapest way to trap unwanted rodents. They are an efficient and effective tool in the pest control industry. However, the sight of a deceased rodent, which has expired in the trap, is not very appealing. The current invention provides a housing for the trap in which the housing is formed of any suitable opaque material, such that the trap and expired rodent are not easily viewed. The housing can be made of cardboard, plastic, metal or any other suitable material.

In one embodiment the housing is made of a disposable material and of particular size and shape to house the trap. The housing contains a signaling means, which alerts the user that the trap has been activated. The signaling means can be electronic or mechanical. In one embodiment, the trap is a swath of colored material protruding from the roof. When the trap is activated the action of the trap arm grabs material that is on the inside of the housing. This material is than pulled in its entirety into the housing. When the user notices the absence of the signaling material, the user may than close the housing and discard the entire housing and apparatus. Optionally, the user can open the housing, slide out the expired rodent and reuse the box with a fresh trap.

The housing also provides several other functions. It protects the user from accessing the trap and thus can be a successful way to prevent personal injury from a user accidently contacting and triggering a spring-loaded trap. Additionaly, the housing could retain any fluids that may emanate from an expired rodent which has been trapped.

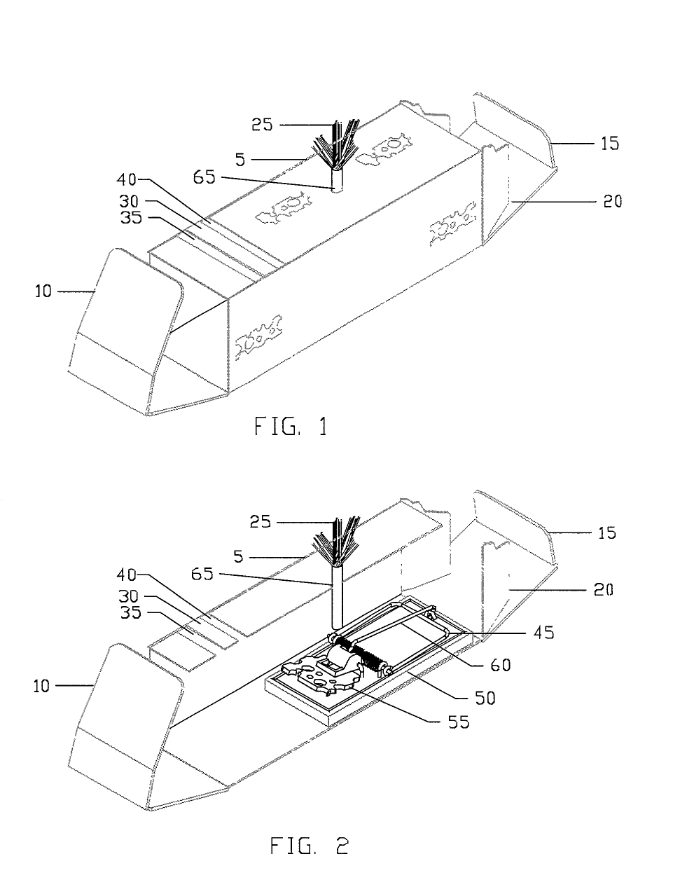

FIG. 1 show housing 5 which is formed of cardboard. It has side flaps 10 and 15 and transverse folding flap 20. Optionally, the flap can be closed by placing the flap in slot 35 under member 30 or over member 30 into slot 40. Side flap 10 is left open, which allows the rodent to enter. Side flap 15 is closed onto transverse flap 20 in order to effectuate a one-way entrance into the housing. Signaling means 25 exits the housing through port 65.

FIG. 2 shows a cross-sectional cut away of the housing indicating the placement of trap 50 within the housing 5. The trap as a bait tray 55 trigger arm 60 and trap arm 45.

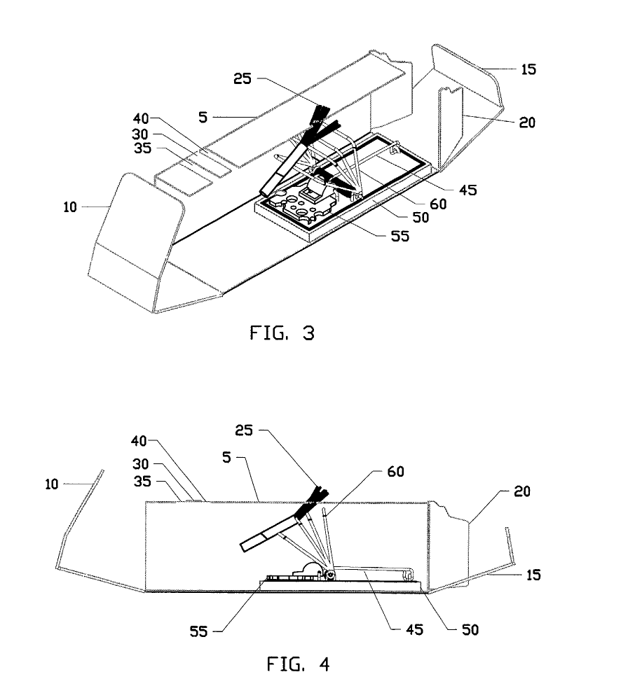

FIG. 3 shows the signaling means 25 being pulled into the housing 5 by trigger arm 60. All other numbered elements are as previously described.

FIG. 4 shows a side view of essentially the same mechanism as FIG. 3. It shows the signaling means 25 being pulled into the housing 5 by trigger arm 60. All other numbered elements are as previously described.

The method of using the apparatus involves placing the trap inside the housing. Closing one end of the housing while leaving the opposite end open. When the rodent enters and triggers the trap, the signaling means is activated. When the user observes the trap has been triggered, the user than closes the one open end and discards the entire assembly. Optionally, the user may open the housing and remove the expired rodent and reuse with a fresh trap.

The assembly is inexpensive, disposable reliable and effective in rodent control.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An apparatus for trapping and disposing rodents comprising:
(a) a rodent trap;
(b) an opaque housing;
(c) a signaling means; and
(d) a means of disposing the trap while keeping the expired rodent from view.

2. The apparatus of claim 1 wherein the rodent trap is a standard spring-loaded trap.

3. The apparatus of claim 1 wherein the opaque housing is open on one side.

4. The apparatus of claim 1 wherein the signaling means is an electronic or mechanical indicator.

5. The apparatus of claim 1 wherein the signaling means is a mechanical indicator.

6. The apparatus of claim 1 wherein the signaling means is viewable from the outside the housing.

7. The apparatus of claim 1 wherein the signaling does not require the user to look inside the housing.

8. The apparatus of claim 1 wherein the means of disposing the trap comprises the steps of:
(a) observing the signaling means has been activated;
(b) closing the previously open end of the housing;
(c) disposing of the housing, activated trap, and expired rodent.

9. A method for trapping and disposing of rodents while keeping the expired rodent hidden from view comprising the steps of:
(a) placing a spring-loaded trap inside the housing;
(b) closing one end of the housing;
(c) leaving one end of the housing open;
(d) placing the trap in a location where the user suspects rodents are present;
(e) observing the signal means has been activated;
(f) closing the previously open end of the housing;
(g) disposing the housing, trap and expired rodent in an appropriate manner.
